(19) United States
(12) Patent Application Publication
(10) Pub. No.: US 2008/0190625 A1
(43) Pub. Date: Aug. 14, 2008

(54) Combination hoof pick and illumination device

(76) Inventor: Walter R. Gibbs, Trivoli, IL (US)

Correspondence Address: THE INVENTORS NETWORK, INC., 332 ACADEMY STREET, CARNEGIE, PA, 15106, US

(21) Appl. No.: 11/703,754

(22) Filed: Feb. 8, 2007

(51) Int. Cl. A01L 11/00

(52) U.S. Cl. 168/48.1; 362/253

(57) ABSTRACT

A combination hoof pick and illumination device for performing maintenance on the hooves of equines, such as horses, in poorly lighted areas such as narrow stalls, and at dusk and during the night, includes a handle having a removable cap that defines an illumination end. The illumination end includes a lens through which battery generated light shines, and centrally mounted to the lens is a boss to which various types of tools and implements are attachable to and detachable therefrom for performing specific maintenance operations, such as picking and cleaning the equines hooves, with the interchangeable tools including a straight pick, a right-angled pick and a wrench.

### FIELD OF THE INVENTION

The present invention pertains to combination devices for animal care and husbandry, and more particularly pertains to a combination or two-in-one device that illuminates the hoof of an equine for checking, picking and cleaning by an implement or tool attached to the device.

### BACKGROUND OF THE INVENTION

The hooves on animals, especially the hooves on equines such as horses, ponies, mules, burrows and the like, require continual care and maintenance to maintain a healthy and pain free condition. Such daily care and maintenance is required to minimize and prevent debilitating, and often life-threatening, infection and injury. Infection and injury result from foreign material, such as stones, feces, straw and other hard objects collecting within and impacting the open area on the underside of the hoof referred to as the frog. If such objects are not promptly removed, the animal will experience pain, injury, infections and lameness, and if left unattended, the life of the animal may be at risk. Lameness results from a fungus called thrush that grows amidst the various materials and objects impacted and embedded within the open area of the underside of the hoof, and which remain there for some time. Given the cost of such animals, especially if they are used for show and racing purposes, the prompt removal of such objects is a requirement for any responsible owner of animals, especially animals of the equine species.

However, it is often the case that the owner of a horse must remove materials and objects from the hooves not in an open, well-lighted day setting but at night, at dusk, or in a narrow, poorly lighted stall. The individual thus requires some type of hoof pick and a portable means to illuminate the underside of the hoof that is to be checked and cleaned. One expedient is to use a standard flashlight in conjunction with a hoof pick with the individual holding the flashlight in one hand and the hoof pick in the other hand. This can present problems as horses can be spooked by light, and with both hands occupied the individual is less easily able to protect himself or herself should the horse suddenly move or kick.

Thus, the prior art discloses a number of tools and implements for the care and maintenance of equine hooves wherein several functions are combined in one device.

For example, Cullen (U.S. design Pat. 243,541) discloses a hoof pick having a curvilinear form with the handle end in the shape of a horse's head and the pick end also having the shape of a horse's head.

The Thombury et al. patent (U.S. Pat. No. 5,168,935) discloses a horse hoof pick including an applicator that comprises a tubular handle having a spray pump nozzle extending from one end that communicates with an internal take-up straw and an application substance contained within an internal cavity of the handle, and a hoof pick externally projecting from the opposite end of the horse hoof pick device.

The Tippin patent (U.S. Pat. No. 5,176,222) discloses a hoof pick tool that includes a handle to which a hoof pick is pivotally mounted at one end. When the hoof pick is closed upon the handle an open space is defined between the pick and the handle so that a belt or belt loop can be passed therethrough for handy attachment and portability of the tool.

The Pitchford patent (U.S. Pat. No. 5,636,697) discloses a tool for cleaning the hooves of equine species and which includes an elongated flattened handle having a pick member extending from one end and a blade member extending from an opposite end.

The Bison et al. patent (U.S. design Pat. D 443,396 S) discloses a hoof pick having a pick integrally formed from a handle and located in the same plane as the handle, and the handle includes an aperture for attaching or suspending the hoof pick from a hook or for passing a rope or cord therethrough.

The Bereuter patent (U.S. design Pat. D 444,272 S) discloses a hoof pick having an ornamental handle in the shape of a horse head, and a pick integrally extending from the handle.

Despite the ingenuity of the above devices, there remains a need for an equine hoof pick that incorporates an illumination means so that an individual can check and clean the hooves of an equine at dusk, at night, or in poorly lighted locations, and to which interchangeable hoof picking and cleaning implements can be attached.

### SUMMARY OF THE INVENTION

The present invention comprehends a combination or two-in-one device or tool that allows an individual to perform various types of maintenance on the hooves of equines, such as horses, at dusk, at night or in poorly lighted, dark and confined spaces such as animal stalls and trailers. The combination tool is lightweight, portable and handy to use, transport and store.

The combination device can be referred to as a combination hoof pick with illumination capabilities, and includes a cylindrical handle having a first end and a second interior end. The handle defines an interior chamber for placement therein of the power generation means, preferably two C-size batteries, for producing the illumination. An off/of switch or button is mounted to the exterior surface of the handle, and in interconnection with the power generation means, for controlling device illumination. A cap is removably securable to the interior second end of the handle, and the cap includes an annular lens (colored if desired) and a boss molded to the lens and which projects outwardly therefrom. The lens is circumjacent the boss, and the boss is axially aligned with the handle when the cap is secured to the second end of the handle. At least one bulb is mounted within the interior cavity of the cap adjacent the lens and the bulb is mounted in such manner so that the bulb is not completely obstructed by the boss when the device is turned on for directing light onto the hoof of the horse.

The boss includes a centrally located blind hole that can be internally threaded, and removably insertable into the hole is an attachment end of a tool or implement that is specifically used for checking, picking and cleaning the hooves, including the crevices and cracks thereof; and such a tool or implement can include a right-angled pick, a straight pick, or a wrench.

It is an objective of the present invention to provide a combination hoof pick and illumination device for cleaning the hooves of an equine, such as a horse, at dusk, night, or in poorly lighted, dark and confined areas such as stalls.

It is another objective of the present invention to provide a combination hoof pick and illumination device for cleaning the hooves of an equine, such as a horse, and to which various kinds of tools and implements are interchangeably attachable for performing specific cleaning and maintenance functions.

It is yet another objective of the present invention to provide a combination hoof pick and illumination device for cleaning the hooves of an equine, such as a horse, that is easily portable so that the hooves can be checked at any time of the day and night for problems and general maintenance.

It is still yet another objective of the present invention to provide a combination hoof pick and illumination device for cleaning the hooves of an equine, such as a horse, that provides enough light for the individual to clearly see the hoof to be checked and cleaned, but doesn't provide so much light as to easily spook the horse.

Still yet another objective of the present invention is to provide a combination hoof pick and illumination device for cleaning the hooves of an equine, such as a horse, wherein the lens for the device may be transparent or colored.

These and other objects, features, and advantages will become apparent to those skilled in the art upon a perusal of the following detailed description read in conjunction with accompanying drawing figures and appended claims.

### BRIEF DESCRIPTION OF THE DRAWINGS

FIG. 1 is a perspective view of the combination hoof pick and illumination device of the present invention illustrating a right-angled hoof pick extending from the illumination end of the device and which is coaxial with the handle of the device;

FIG. 2 is a perspective view of the combination hoof pick and illumination device of the present invention illustrating the device in use for performing maintenance on the hooves of an equine, such as a horse;

FIG. 3 is an exploded assembly view of the combination hoof pick and illumination device of the present invention illustrating the interconnection and assembly of the various structural components that comprise the device;

FIG. 4 is a perspective view of the combination hoof pick and illumination device of the present invention illustrating the securement of an attachable and detachable tool, such as a wrench, to the illumination end of the device;

FIG. 5 is a perspective view of the combination hoof pick and illumination device of the present invention illustrating the securement of an attachable and detachable tool, such as a straight pick, to the illumination end of the device;

FIG. 6 is an elevational view of the combination hoof pick and illumination device of the present invention illustrating the insertion of the right-angled hoof pick into a crevice on the underside of a hoof of the horse for checking, picking and cleaning that hoof; and

FIG. 7 is a representative electrical schematic for the combination hoof pick and illumination device of the present invention.

### DETAILED DESCRIPTION OF THE PREFERRED EMBODIMENT

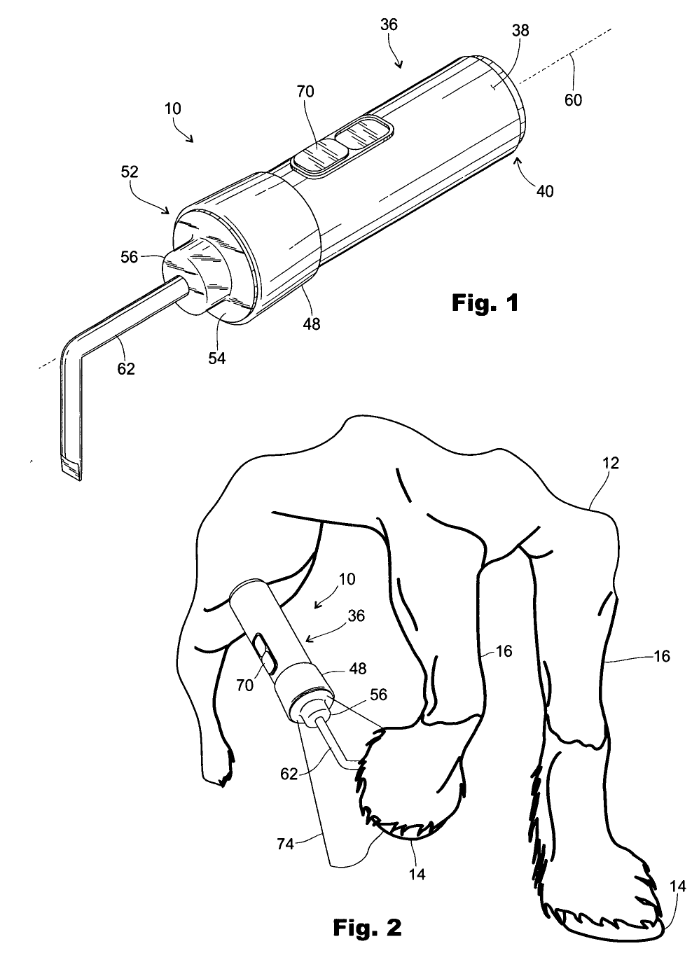

Illustrated in FIGS. 1-7 is a combination or two-in-one device 10 for performing maintenance on animals, and which is especially adapted for use with hoofed animals of the species equine, i.e., horses, donkeys, burrows, mules. The two-in-one device 10 combines in a lightweight, portable, easy-to-use handheld device the capabilities of a flashlight and a hoof pick so that the individual, such as a farmer, horse trainer or horse breeder, can perform the necessary maintenance on the equine's hoofs to keep the equine free from infection and injury. The device 10 of the present invention is adapted for checking, picking and cleaning the hoof of an equine at dusk, at night, and in poorly or inadequately lighted, narrows areas such as animal stalls and trailers. Since debris such as dirt, stones, pebbles, broken glass, wood chips, straw, feces and the like can collect on the underside of the hoof at any time, the device 10 of the present invention is available to remove such debris at any hour of the day and night thereby maintaining the good health of the animal, such as a horse.

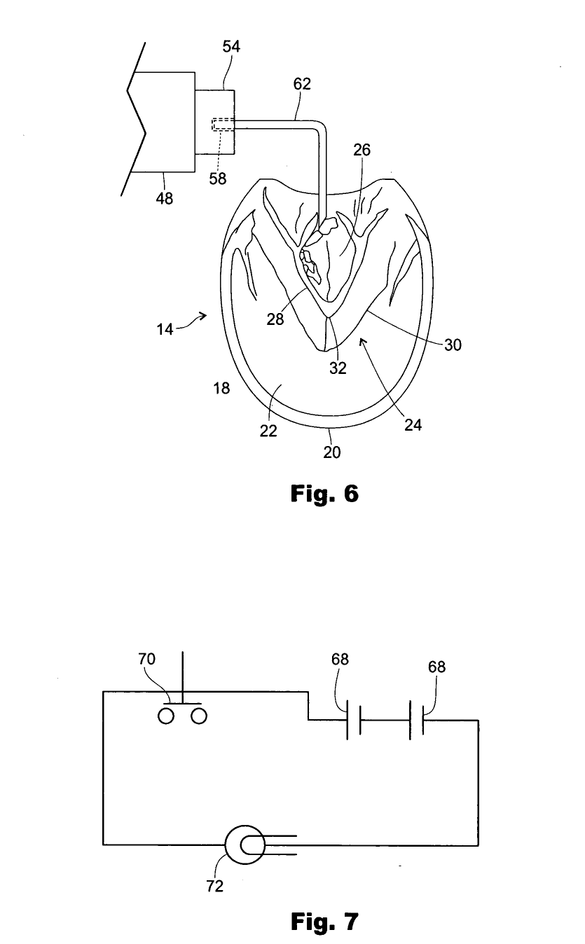

Illustrated in FIGS. 2 and 6 is a representative hoofed animal 12, such as a horse, showing the device 10 being used specifically on the hoof 14 of one of the front legs 16 of the horse. FIG. 7 illustrates the underside 18 of one hoof 14 that includes a toe 20, a sole 22, and a frog 24. The frog 24 is further defined by central groove 26, with the central groove 26 flanked by a continuous ridge 28. The central ridge 28 is bounded by a lateral groove 30 and includes an apex 32 extending toward the toe 20 of the hoof 14. It is in the crevices, fissures and cracks on the underside 18 of the hoof 14, and about the frog 24, the debris and material collects and must be removed therefrom. As will be more fully explained, the device 10 is shown in FIGS. 2 and 7 picking and cleaning debris 34, such as small pebbles, stones and the like, from the underside 18 of the hoof 14 adjacent the frog 24.

Illustrated in FIGS. 1 and 3-5, and 7 is the combination hoof pick and illumination device 10 that includes an elongated and cylindrical handle 36. The handle 36 includes a casing or housing having an exterior continuous surface 38. The handle 36 includes a first end 40 and an opposite interior second end 42. Extending from the first end 40 to the second end 42 is an interior chamber 44, and the second end 42 includes exterior annular threads 46.

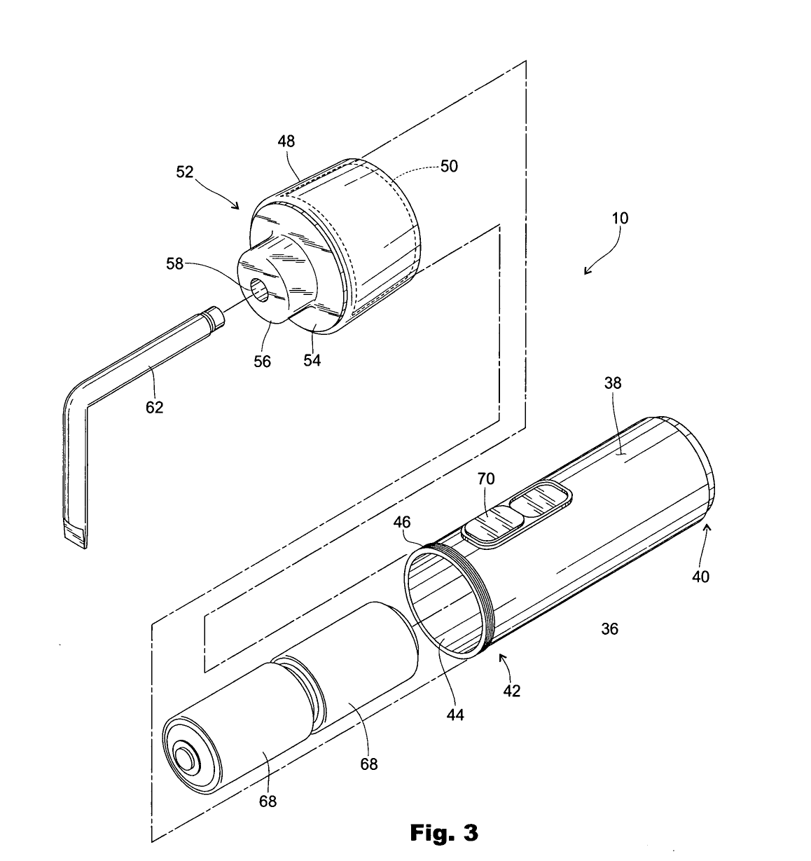

A cap 48 is removably attachable to the second end 42 of the handle 36. The cap 48 defines an interior cavity 50, as shown in FIG. 3, and the interior cavity 50 includes interior annular threads (not shown) that mate with the exterior annular threads 46 at the second end 42 of the handle 36 for allowing the cap 48 easy attachment to and detachment from the handle 36. The cap 48 includes a distal end 52, and mounted to the distal end 52 is an annular lens 54. The lens 54 is transparent, but can be colored if desired.

As shown in FIGS. 1-5, a boss or hoof tool housing 56 is centrally and integrally mounted to the lens 54 and projects outwardly therefrom with the lens 54 thus being circumjacent relative to the boss 56. It should be noted that the boss 56 could be molded directly to the lens 54. The boss 56 includes a blind hole 58 that can be internally threaded. The assembly of the device 10 is shown in FIG. 3, and when assembled the handle 36, the cap 48 and the boss 56 are in axial alignment with each other as indicated by the longitudinal axis line 60 extending through the aforementioned elements.

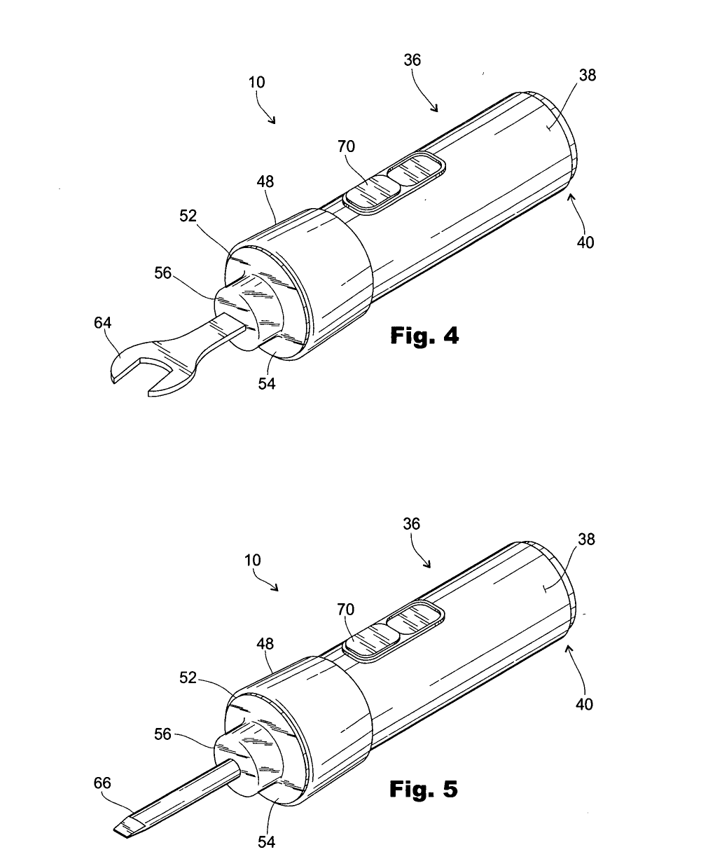

As illustrated in FIGS. 1-6, a hoof picking means is detachably securable to the boss 56, and is specifically insertable into and removable from the blind hole 58 of the boss 56. The hoof picking means can include a variety of tools and implements for performing the necessary maintenance on the underside 18 of the hoof 14 for checking, picking, cleaning and removing debris 34 therefrom. Thus, as shown in FIGS. 1-3 and 6, the hoof picking means is a tool in the form of a right-angled hoof pick 62; as shown in FIG. 4 the hoof picking means is a tool in the form of a wrench 64; and as shown in FIG. 5 the hoof picking means is a tool in the form of a straight pick 66. The right-angled pick 62, the wrench 64, and the straight pick 66 are adapted to be interchangeably attachable to and detachable from the boss 56 of the cap 48 thereby enhancing the usefulness of the device 10.

The two-in-one device 10 includes an illumination means that complements and enhances the hoof picking and cleaning functions. Specifically, as shown in FIGS. 3 and 7, the illumination means includes a power source preferably in the form of two C-size batteries 68 that are disposed within the chamber 44 of the handle 36. Mounted to the exterior surface 38 of the housing of the handle 36, and in electrical interconnection with the batteries 68, is a slidable on and off switch or button 70. Further, a bulb 72 is mounted within the cap 48 and adjacent the lens 54 in such a manner that when the switch 70 is pushed or slid to the on position, the bulb 72 produces and directs light 74 in a tight circle that extends about and past the boss 56 and the tool, such as the right-angled tool 62 as shown in FIG. 2, for illuminating the underside 18 of the hoof 14. FIG. 7 is a representative electrical schematic that illustrates the electrical interconnection of the slidable switch 70, the batteries 68, and the bulb 72. Enough light 74 is generated to illuminate the underside 18 of the hoof 14; and it should be noted that the bulb 72 of the present invention doesn't generate light that is so intense or bright as to spook the animal 12 (the horse), which could happen if a high intensity halogen or fluorescent bulb were used instead.

While a preferred embodiment of the combination or two-in-one device has been shown and described, it will be apparent to those skilled in the art that the invention may be embodied otherwise without departing from the spirit of the invention or the scope of the invention as set forth in the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A combination hoof pick and illuminating device for performing maintenance on the underside of a hoof of an animal, comprising:
a handle having a first end, a continuous exterior surface, and an interior second end;
an chamber extending from the first end to the second end;
at least two batteries for disposition within the chamber;
an on/off switch mounted to the continuous exterior surface of the handle and in electrical interconnection with the batteries;
a cap for removable attachment to the exterior second end of the handle;
the cap including an interior cavity and a distal end;
an annular lens mounted to the distal end of the cap;
a boss centrally mounted to the lens and extending outwardly therefrom;
the boss, the cap and the handle in axial alignment with each other when assembled and attached together;
a right-angled pick that is detachably securable to the boss and which is used to clean the underside of the hoof of the horse by digging and pulling dirt and debris from the underside or the hoof of the horse; and
a bulb disposed within the interior cavity of the cap adjacent the lens and in electrical interconnection with batteries for illuminating the underside of the hoof with a concentrated light cone that will spook the animal but will provide sufficient light for performing maintenance on the hoof.

14. The combination hoof pick and illumination device of claim 13 wherein the right-angled hoof pick is drug across the underside of the hoof of the horse so as not to injure the horse.
